(19) United States
(12) Patent Application Publication
(10) Pub. No.: US 2009/0271021 A1
(43) Pub. Date: Oct. 29, 2009

(54) Execution system for the monitoring and execution of insulin manufacture

(76) Inventor: Shane M. Popp, Santa Monica, CA (US)

Correspondence Address: Shane M. Popp;SMP Logic Systems LLC, Intellectual Property Department, 2804 6th Street, Santa Monica, CA, 90405, US

(21) Appl. No.: 12/386,989

(22) Filed: Apr. 23, 2009

Related U.S. Application Data
(60) Provisional application No. 61/125,714, filed on Apr. 28, 2008.

(51) Int. Cl. G06F 17/00

(52) U.S. Cl. 700/110

(57) ABSTRACT

Execution systems and methods thereof used to monitor and execute an insulin manufacturing process are disclosed herein. Consequently, the methods and systems provide a means to perform validation and quality manufacturing on an integrated level whereby insulin manufacturers can achieve data and product integrity and ultimately minimize cost.

### CROSS-REFERENCE TO RELATED APPLICATIONS

This application claims priority to U.S. Provisional Patent Application No. 61/125,714 filed 28 Apr. 2008, the contents of which are fully incorporated by reference herein.

### STATEMENT OF RIGHTS TO INVENTIONS MADE UNDER FEDERALLY SPONSORED RESEARCH

Not applicable.

### FIELD OF THE INVENTION

The invention described herein relates to the field of insulin manufacturing. Specifically, execution systems and methods used for the monitoring and execution of insulin manufacture. The invention further relates to the enhancement of computer system technologies and information technology to produce higher quality more efficient insulin.

### BACKGROUND OF THE INVENTION

Previously we have described novel methods, systems, software programs, and manufacturing execution systems for validation, quality and risk assessment, and monitoring of pharmaceutical manufacturing processes. See, US2005/0251278 published 10 Nov. 2005; US2006/0276923 published 7 Dec. 2006; US2006/0271227 Published 30 Nov. 2006; US2007/0021856 Published 25 Jan. 2007; and US2007/0032897 Published 8 Feb. 2007. Additionally, we endeavor to further the state of the art using software and computer programming in the field of insulin manufacture.

Diabetes is a disease in which your blood glucose, or sugar, levels are too high. Glucose comes from the foods you eat. Insulin is a hormone that helps the glucose get into your cells to give them energy. People can get diabetes at any age. There are three main kinds. Type 1 diabetes, formerly called juvenile diabetes or insulin-dependent diabetes, is usually first diagnosed in children, teenagers, or young adults. With this form of diabetes, the beta cells of the pancreas no longer make insulin because the body's immune system has attacked and destroyed them. Treatment for type 1 diabetes includes taking insulin, making wise food choices, being physically active, taking aspirin daily (for some), and controlling blood pressure and cholesterol.

Type 2 diabetes, formerly called adult-onset diabetes or noninsulin-dependent diabetes, is the most common form of diabetes. People can develop type 2 diabetes at any age—even during childhood. This form of diabetes usually begins with insulin resistance, a condition in which fat, muscle, and liver cells do not use insulin properly. At first, the pancreas keeps up with the added demand by producing more insulin. In time, however, it loses the ability to secrete enough insulin in response to meals. Being overweight and inactive increases the chances of developing type 2 diabetes. Treatment includes using diabetes medicines, making wise food choices, being physically active, taking aspirin daily, and controlling blood pressure and cholesterol.

Finally, some women develop Gestational diabetes during the late stages of pregnancy. Although this form of diabetes usually goes away after the baby is born, a woman who has had it is more likely to develop type 2 diabetes later in life. Gestational diabetes is caused by the hormones of pregnancy or a shortage of insulin.

Common signs of diabetes are being very thirsty, urinating often, feeling very hungry or tired, losing weight without trying, having sores that heal slowly, having dry, itchy skin, losing the feeling in your feet or having tingling in your feet, and having blurry eyesight. Persons may have had one or more of these signs before you found out you had diabetes. Or persons may have had no signs at all. A blood test to check your glucose levels will properly show if you have pre-diabetes or diabetes.

Many people with diabetes take insulin to control their blood sugar (glucose). Insulin cannot be taken by mouth because it would be destroyed by digestion. Instead, most people who need insulin take insulin shots. Other ways to take insulin include insulin pens, insulin jet injectors, and insulin pumps. Currently, there are more than 20 types of insulin products available in four basic forms, each with a different time of onset and duration of action. The decision as to which insulin to choose is based on an individual's lifestyle, a physician's preference and experience, and the person's blood sugar levels. Among the criteria considered in choosing insulin are how soon it starts working (onset), when it works the hardest (peak time), how long it lasts in the body (duration). Since 1982, most of the newly approved insulin preparations have been produced by inserting portions of DNA (“recombinant DNA”) into special lab-cultivated bacteria or yeast. This process allows the bacteria or yeast cells to produce complete human insulin. Recombinant human insulin has, for the most part, replaced animal-derived insulin, such as pork and beef insulin. More recently, insulin products called “insulin analogs” have been produced so that the structure differs slightly from human insulin (by one or two amino acids) to change onset and peak of action. Onset, peak, and duration of action are approximate for each insulin product, as there may be variability depending on each individual, the injection site, and the individual's exercise program. The insulin products used by people with diabetes are either taken from animals (pigs or cows) or manufactured in labs to be identical to human insulin. Beef insulin is no longer available in the United States. Beginning in January 2006, pork insulin for human use is no longer be manufactured or marketed in the U.S. The Center for Disease Control and Prevention has reported that from 1980 through 2005 the number of adults aged 18-79 with newly diagnosed diabetes almost tripled from 493,000 in 1980 to 1.4 million in 2005 in the United States. Current trends suggest that this number is continuing to grow at an alarming pace. Accordingly, the ability to manufacture high quality insulin at a consistent level is crucial to manage this disease.

Additionally, the globalization of insulin manufacturing requires a global approach to integration keeping in mind the overall objective of strong public health protection. To accomplish these needed goals there is a need to carry out the following actions. The artisan should use emerging science and data analysis to enhance validation and quality assurance programs during the manufacturing process. From the aforementioned, also apparent to one of ordinary skill in the art is the ability to provide an integrated approach to manufacturing whereby quality and manufacturing variables are monitored continuously during manufacture. By providing an integrated and user-friendly approach to validation and quality assurance, the overall benefit to the public at-large is end products containing insulin available at lower costs. This is turn will allow more persons or animals to benefit from innovations that occur in the treatment of disease, such as diabetes.

Given the current deficiencies associated with insulin manufacture and the fact that the demand from a public health standpoint is increasing, it becomes clear that providing an integrated systems approach to insulin manufacture is desirable. Specifically, producing insulin from a “quality by design” approach (i.e. where quality is in designed in the production versus testing quality post-production) is advantageous. The present invention provides this solution.

### SUMMARY OF THE INVENTION

The invention provides for execution systems (denoted herein as execution system or ES) and methods thereof designed for use in manufacturing insulin. Specifically, software programs that monitor quality control and the quality process used in the manufacture, processing, and storing of insulin. In certain embodiments, the software programs are used in a continuous manner to ensure purity and consistency of an ingredient used in insulin manufacture.

The invention further comprises a software program that is fully integrated and automated to monitor the entire insulin manufacturing process.

The invention further comprises integrating the execution system into an insulin manufacturing system whereby control of the insulin manufacturing process is attained.

In certain embodiments, the ES is integrated into an Insulin synthesis system used in insulin manufacturing.

In certain embodiments, the ES is integrated into an insulin fermentation system used in insulin manufacturing.

In certain embodiments, the ES is integrated into a DNA extraction system used in insulin manufacturing.

In certain embodiments, the ES is integrated into a centrifuge system used in insulin manufacturing.

In certain embodiments, the ES is integrated into a chromatography system used in insulin manufacturing.

In certain embodiments, the ES is integrated into a purification systems used in insulin manufacturing.

In certain embodiments, the ES is integrated into a packaging system used in insulin manufacturing.

In certain embodiments, the execution system comprises a software program with a computer memory having computer readable instructions.

In certain embodiments, the execution system continuously monitors the insulin manufacturing process.

In certain embodiments, the execution system semi-continuously monitors the insulin manufacturing process.

Based on the foregoing non-limiting exemplary embodiments, the software program can be interfaced with hardware systems or software systems to monitor quality assurance protocols put in place by the quality control unit.

The invention further comprises an execution system which integrates application software and methods disclosed herein to provide a comprehensive validation and quality assurance protocol that is used by a plurality of end users whereby the data compiled from the system is analyzed and used to determine if quality assurance protocols and validation protocols are being achieved.

The invention further comprises implementing the execution systems and software program to multiple insulin product lines whereby simultaneous insulin production lines are monitored using the same system.

The invention further comprises implementation of the execution system and software program described herein into the amino acid sequencing, fermentation, blending, centrifuge, ion-exchange chromatography, reverse high-performance liquid chromatography, gel filtration chromatography, x-ray crystallography, and package testing subset of the insulin manufacturing process whereby the data compiled by the subset processes is tracked continuously overtime and said data is used to analyze the subset processes and whereby said data is integrated and used to analyze the quality control process of the insulin manufacturing process at-large.

The invention further comprises an execution system, which controls the insulin manufacturing process and increases productivity and improves quality of insulin over time.

### BRIEF DESCRIPTION OF THE FIGURES

FIG. 1. General Schematic of Insulin Manufacturing Process. As shown in the figure. The first step is synthesis of the insulin protein. This can be done starting with the human insulin A and B chain, proinsulin, or an insulin analog. The second step is fermentation followed by DNA extraction followed by purification and finally packaging of the insulin product.

FIG. 2. Schematic of an Execution System integrated into an Insulin Synthesis Process. As shown in the figure, the entire insulin synthesis system is integrated into an execution system. Data is monitored at critical control points to ensure quality parameters are being achieved. The data is monitored and analyzed on a continuous basis.

FIG. 3. Schematic of an Execution System integrated into a fermentation and DNA extraction system used in insulin manufacture. As shown in the figure, the entire fermentation and DNA extraction system is integrated into the Execution System. Data is monitored at critical control points to ensure quality parameters are being achieved. The data is monitored and analyzed on a continuous basis.

FIG. 4. Schematic of an Execution System integrated into a purification system used in insulin manufacture. As shown in the figure, the entire insulin purification system is integrated into the Execution System. Data is monitored at critical control points to ensure quality parameters are being achieved. The data is monitored and analyzed on a continuous basis.

FIG. 5. Schematic of an Execution System integrated into a packaging system used in insulin manufacture. As shown in the figure, the entire insulin packaging system is integrated into the Execution System. Data is monitored at critical control points to ensure quality parameters are being achieved. The data is monitored and analyzed on a continuous basis.

### DETAILED DESCRIPTION OF THE INVENTION

Outline of Sections

I.) Definitions

II.) Software Program and Computer Product

III.) Analysis

IV.) Execution System(s)

V.) KITS/Articles of Manufacture

VI.) Background to Insulin Manufacturing

I.) Definitions:

Unless otherwise defined, all terms of art, notations and other scientific terms or terminology used herein are intended to have the meanings commonly understood by those of skill in the art to which this invention pertains unless the context clearly indicates otherwise. In some cases, terms with commonly understood meanings are defined herein for clarity and/or for ready reference, and the inclusion of such definitions herein should not necessarily be construed to represent a substantial difference over what is generally understood in the art. Many of the techniques and procedures described or referenced herein are well understood and commonly employed using conventional methodology by those skilled in the art, such as, for example, the widely utilized current Good Manufacturing Practice guidelines.

As used herein the term “diabetes” means a common disease wherein the failure to make insulin or to respond to it constitutes diabetes mellitus. Insulin is made specifically by the beta cells in the islets of Langerhans in the pancreas. If the beta cells degenerate so the body cannot make enough insulin on its own, type I diabetes results. A person with this type of diabetes (and others) must inject exogenous insulin (insulin from sources outside the body).

“insulin” means a natural hormone made by the pancreas that controls the level of the sugar glucose in the blood. Insulin permits cells to use glucose for energy. Cells cannot utilize glucose without insulin.

“interface” means the communication boundary between two or more entities, such as a piece of software, a hardware device, or a user. It generally refers to an abstraction that an entity provides of itself to the outside. This separates the methods of external communication from internal operation, and allows it to be internally modified without affecting the way outside entities interact with it, as well as provide multiple abstractions of itself. It may also provide a means of translation between entities that do not speak the same language, such as between a human and a computer. The interface between a human and a computer is called a user interface. Interfaces between hardware components are physical interfaces. Interfaces between software exist between separate software components and provide a programmatic mechanism by which these components can communicate.

“abstraction” means the separation of the logical properties of data or function from its implementation in a computer program.

“algorithm” means any sequence of operations for performing a specific task.

“algorithm analysis” means a software verification and validation (“V&V”) task to ensure that the algorithms selected are correct, appropriate, and stable, and meet all accuracy, timing, and sizing requirements.

“analog” means pertaining to data [signals] in the form of continuously variable [wave form] physical quantities; e.g., pressure, resistance, rotation, temperature, voltage.

“analog device” means a device that operates with variables represented by continuously measured quantities such as pressures, resistances, rotations, temperatures, and voltages.

“analog-to-digital converter” means input related devices which translate an input device's [sensor] analog signals to the corresponding digital signals needed by the computer.

“analysis” means a course of reasoning showing that a certain result is a consequence of assumed premises.

“application software” means software designed to fill specific needs of a user.

“bar code” means a code representing characters by sets of parallel bars of varying thickness and separation that are read optically by transverse scanning.

“basic input/output system” means firmware that activates peripheral devices in a PC. Includes routines for the keyboard, screen, disk, parallel port and serial port, and for internal services such as time and date. It accepts requests from the device drivers in the operating system as well from application programs. It also contains autostart functions that test the system on startup and prepare the computer for operation. It loads the operating system and passes control to it.

“benchmark” means a standard against which measurements or comparisons can be made.

“block check” means the part of the error control procedure that is used for determining that a block of data is structured according to given rules.

“bootstrap” means a short computer program that is permanently resident or easily loaded into a computer and whose execution brings a larger program, such an operating system or its loader, into memory.

“boundary value” means a data value that corresponds to a minimum or maximum input, internal, or output value specified for a system or component.

“boundary value analysis” means a selection technique in which test data are chosen to lie along “boundaries” of the input domain [or output range] classes, data structures, procedure parameters, etc.

“branch analysis” means a test case identification technique which produces enough test cases such that each decision has a true and a false outcome at least once.

“calibration” means ensuring continuous adequate performance of sensing, measurement, and actuating equipment with regard to specified accuracy and precision requirements.

“certification” means technical evaluation, made as part of and in support of the accreditation process that establishes the extent to which a particular computer system or network design and implementation meet a pre-specified set of requirements.

“concept phase” means the initial phase of a software development project, in which user needs are described and evaluated through documentation.

“configurable, off-the-shelf software” means application software, sometimes general purpose, written for a variety of industries or users in a manner that permits users to modify the program to meet their individual needs.

“control flow analysis” means a software V&V task to ensure that the proposed control flow is free of problems, such as design or code elements that are unreachable or incorrect.

“controller” means hardware that controls peripheral devices such as a disk or display screen. It performs the physical data transfers between main memory and the peripheral device.

“conversational” means pertaining to a interactive system or mode of operation in which the interaction between the user and the system resembles a human dialog.

“corrective maintenance” means maintenance performed to correct faults in hardware or software.

“critical control point” means a function or an area in a manufacturing process or procedure, the failure of which, or loss of control over, may have an adverse affect on the quality of the finished product and may result in an unacceptable health risk.

“data analysis” means evaluation of the description and intended use of each data item in the software design to ensure the structure and intended use will not result in a hazard. Data structures are assessed for data dependencies that circumvent isolation, partitioning, data aliasing, and fault containment issues affecting safety, and the control or mitigation of hazards.

“data integrity” means the degree to which a collection of data is complete, consistent, and accurate.

“data validation” means a process used to determine if data are inaccurate, incomplete, or unreasonable. The process may include format checks, completeness checks, check key tests, reasonableness checks and limit checks.

“design level” means the design decomposition of the software item; e.g., system, subsystem, program or module.

“design phase” means the period of time in the software life cycle during which the designs for architecture, software components, interfaces, and data are created, documented, and verified to satisfy requirements.

“diagnostic” means pertaining to the detection and isolation of faults or failures.

“different software system analysis” means analysis of the allocation of software requirements to separate computer systems to reduce integration and interface errors related to safety. Performed when more than one software system is being integrated.

“dynamic analysis” means analysis that is performed by executing the program code.

“encapsulation” means a software development technique that consists of isolating a system function or a set of data and the operations on those data within a module and providing precise specifications for the module.

“end user” means a person, device, program, or computer system that uses an information system for the purpose of data processing in information exchange.

“error detection” means techniques used to identify errors in data transfers.

“error guessing” means the selection criterion is to pick values that seem likely to cause errors.

“error seeding” means the process of intentionally adding known faults to those already in a computer program for the purpose of monitoring the rate of detection and removal, and estimating the number of faults remaining in the program.

“failure analysis” means determining the exact nature and location of a program error in order to fix the error, to identify and fix other similar errors, and to initiate corrective action to prevent future occurrences of this type of error.

“Failure Modes and Effects Analysis” means a method of reliability analysis intended to identify failures, at the basic component level, which have significant consequences affecting the system performance in the application considered.

“FORTRAN” means an acronym for FORmula TRANslator, the first widely used high-level programming language. Intended primarily for use in solving technical problems in mathematics, engineering, and science.

“life cycle methodology” means the use of any one of several structured methods to plan, design, implement, test and operate a system from its conception to the termination of its use.

“logic analysis” means evaluates the safety-critical equations, algorithms, and control logic of the software design.

“low-level language” means the advantage of assembly language is that it provides bit-level control of the processor allowing tuning of the program for optimal speed and performance. For time critical operations, assembly language may be necessary in order to generate code which executes fast enough for the required operations.

“maintenance” means activities such as adjusting, cleaning, modifying, overhauling equipment to assure performance in accordance with requirements.

“Pascal” means a high-level programming language designed to encourage structured programming practices.

“path analysis” means analysis of a computer program to identify all possible paths through the program, to detect incomplete paths, or to discover portions of the program that are not on any path.

“quality assurance” means the planned systematic activities necessary to ensure that a component, module, or system conforms to established technical requirements.

“quality control” means the operational techniques and procedures used to achieve quality requirements.

“software engineering” means the application of a systematic, disciplined, quantifiable approach to the development, operation, and maintenance of software.

“software engineering environment” means the hardware, software, and firmware used to perform a software engineering effort.

“software hazard analysis” means the identification of safety-critical software, the classification and estimation of potential hazards, and identification of program path analysis to identify hazardous combinations of internal and environmental program conditions.

“software reliability” means the probability that software will not cause the failure of a system for a specified time under specified conditions.

“software review” means an evaluation of software elements to ascertain discrepancies from planned results and to recommend improvement.

“software safety change analysis” means analysis of the safety-critical design elements affected directly or indirectly by the change to show the change does not create a new hazard, does not impact on a previously resolved hazard, does not make a currently existing hazard more severe, and does not adversely affect any safety-critical software design element.

“software safety code analysis” means verification that the safety-critical portions of the design are correctly implemented in the code.

“software safety design analysis” means verification that the safety-critical portion of the software design correctly implements the safety-critical requirements and introduces no new hazards.

“software safety requirements analysis” means analysis evaluating software and interface requirements to identify errors and deficiencies that could contribute to a hazard.

“software safety test analysis” means analysis demonstrating that safety requirements have been correctly implemented and that the software functions safely within its specified environment.

“system administrator” means the person that is charged with the overall administration, and operation of a computer system. The system administrator is normally an employee or a member of the establishment.

“system analysis” means a systematic investigation of a real or planned system to determine the functions of the system and how they relate to each other and to any other system.

“system design” means a process of defining the hardware and software architecture, components, modules, interfaces, and data for a system to satisfy specified requirements.

“top-down design” means pertaining to design methodology that starts with the highest level of abstraction and proceeds through progressively lower levels.

“validation” means establishing documented evidence which provides a high degree of assurance that a specific process will consistently produce a product meeting its predetermined specifications and quality attributes.

“validation, process” means establishing documented evidence which provides a high degree of assurance that a specific process will consistently produce a product meeting its predetermined specifications and quality characteristics.

“validation, prospective” means validation conducted prior to the distribution of either a new product, or product made under a revised manufacturing process, where the revisions may affect the products characteristics.

“validation protocol” means a written plan stating how validation will be conducted, including test parameters, product characteristics, production equipment, and decision points on what constitutes acceptable test results.

“validation, retrospective” means validation of a process for a product already in distribution based upon accumulated production, testing and control data. Retrospective validation can also be useful to augment initial premarket prospective validation for new products or changed processes. Test data is useful only if the methods and results are adequately specific. Whenever test data are used to demonstrate conformance to specifications, it is important that the test methodology be qualified to assure that the test results are objective and accurate.

“validation, software” means determination of the correctness of the final program or software produced from a development project with respect to the user needs and requirements. Validation is usually accomplished by verifying each stage of the software development life cycle.

“structured query language” means a language used to interrogate and process data in a relational database. Originally developed for IBM mainframes, there have been many implementations created for mini and micro computer database applications. SQL commands can be used to interactively work with a data base or can be embedded with a programming language to interface with a database.

“Batch” means a specific quantity of insulin that is intended to have uniform character and quality, within specified limits, and is produced according to a single manufacturing order during the same cycle of manufacture.

“Component” means any ingredient intended for use in the manufacture of insulin, including those that may not appear in such insulin product.

“Insulin product” means a finished dosage form, for example, tablet, capsule, solution, etc., that contains an active insulin ingredient generally, but not necessarily, in association with inactive ingredients.

“Active insulin ingredient” means any component that is derived from the human or bovine or recombinant insulin amino acids and is intended to furnish pharmacological activity or other direct effect in the diagnosis, cure, mitigation, treatment, or prevention of diabetes (a.k.a. diabetes mellitus) or other related diseases.

“Inactive ingredient” (a.k.a. excipient) means a substance used as a carrier for the active ingredients of an insulin product. In addition, excipients can be used to aid the process by which insulin is manufactured. The active insulin substance is then dissolved or mixed with an excipient. Excipients are also sometimes used to bulk up formulations with active insulin ingredients, to allow for convenient and accurate dosage. Examples of excipients, include but are not limited to, antiadherents, binders, coatings, disintegrants, fillers, dilutents, flavors, colors, lubricants, and preservatives.

“In-process material” means any material fabricated, compounded, blended, or derived by chemical reaction that is produced for, and used in, the preparation of the insulin product.

“Lot number, control number, or batch number” means any distinctive combination of letters, numbers, or symbols, or any combination thereof, from which the complete history of the manufacture, processing, packing, holding, and distribution of a batch or lot of insulin product or active insulin ingredient or other material can be determined.

“Quality control unit” means any person or organizational element designated by the firm to be responsible for the duties relating to quality control.

“Acceptance criteria” means the product specifications and acceptance/rejection criteria, such as acceptable quality level and unacceptable quality level, with an associated sampling plan, that are necessary for making a decision to accept or reject a lot or batch.

“execution system” means an integrated hardware and software solution designed to measure and control activities in the production areas of insulin manufacturing organizations to increase productivity and improve quality. Also referred to as a Manufacturing Execution System (“MES”).

“Process analytical technology” (a.k.a. PAT) means a mechanism to design, analyze, and control pharmaceutical manufacturing processes through the measurement of critical process parameters and quality attributes.

“Chromatography” means collectively a family of laboratory techniques for the separation of mixtures. It involves passing a mixture which contains the analyte through a stationary phase, which separates it from other molecules in the mixture and allows it to be isolated.

II.) Software Program

The invention provides for a software program that is programmed in a high-level or low-level programming language, preferably a relational language such as structured query language which allows the program to interface with an already existing program or a database. Other programming languages include but are not limited to C, C++, FORTRAN, Java, Perl, Python, Smalltalk and MS visual basic. Preferably, however, the program will be initiated in parallel with the insulin manufacturing process or quality assurance (“QA”) protocol. This will allow the ability to monitor the insulin manufacturing and QA process from its inception. However, in some instances the program can be bootstrapped into an already existing program that will allow monitoring from the time of execution (i.e. bootstrapped to configurable off-the-shelf software).

It will be readily apparent to one of skill in the art that the preferred embodiment will be a software program that can be easily modified to conform to numerous software-engineering environments. One of ordinary skill in the art will understand and will be enabled to utilize the advantages of the invention by designing the system with top-down design. The level of abstraction necessary to achieve the desired result will be a direct function of the level of complexity of the process that is being monitored. For example, the critical control point for monitoring an active insulin ingredient versus an inactive ingredient may not be equivalent. Similarly, the critical control point for monitoring an in-process material may vary from component to component and often from batch to batch.

One of ordinary skill will appreciate that to maximize results the ability to amend the algorithm needed to conform to the validation and QA standards set forth by the quality control unit on each step during insulin manufacture will be preferred. This differential approach to programming will provide the greatest level of data analysis leading to the highest standard of data integrity.

The preferred embodiments may be implemented as a method, system, or program using standard software programming and/or engineering techniques to produce software, firmware, hardware, or any combination thereof. The term “computer product” as used herein is intended to encompass one or more computer programs and data files accessible from one or more computer-readable devices, firmware, programmable logic, memory devices (e.g. EEPROM's, ROM's, PROM's, RAM's, SRAM's, etc.) hardware, electronic devices, a readable storage diskette, CD-ROM, a file server providing access to programs via a network transmission line, wireless transmission media, signals propagating through space, radio waves, infrared signals, etc.

The invention further provides articles (e.g., computer products) comprising a machine-readable medium including machine-executable instructions, computer systems and computer implemented methods to practice the methods of the invention. Accordingly, the invention provides computers, computer systems, computer readable mediums, computer programs products and the like having recorded or stored thereon machine-executable instructions to practice the methods of the invention. As used herein, the words “recorded” and “stored” refer to a process for storing information on a computer medium. A skilled artisan can readily adopt any known methods for recording information on a computer to practice the methods of the invention.

The computer processor used to practice the methods of the invention can be a conventional general-purpose digital computer, e.g., a personal workstation computer, including conventional elements such as microprocessor and data transfer bus.

In one embodiment, the invention provides for methods of interfacing a software program with a insulin manufacturing system whereby the software program is integrated into the insulin manufacturing process and control of the insulin manufacturing process is attained. The integration can be used for routine monitoring, quality control, maintenance, hazard mitigation, validation, etc.

The invention further comprises implementing the software program to multiple devices used in insulin manufacture to create an execution system used to monitor and control the entire insulin manufacturing process.

The invention further comprises implementing the execution system into multiple insulin product lines whereby simultaneous insulin production lines are monitored using the same system.

The invention further comprises implementation of the execution system and software program described herein into the amino acid sequencing, fermentation, blending, centrifuge, ion-exchange chromatography, reverse high-performance liquid chromatography, gel filtration chromatography, x-ray crystallography, and package testing subset of the insulin manufacturing process whereby the data compiled by the subset processes is tracked continuously overtime and said data is used to analyze the subset processes and whereby said data is integrated and used to analyze the quality control process of the insulin manufacturing process at-large.

It will also be appreciated by those skilled in the art that the various steps herein for insulin production are not required to be all performed or exist in the same production series. Thus, while in some embodiments, all steps and/or software programs and/or execution systems described or mentioned herein are performed or exist, in other embodiments, one or more steps are optionally, e.g., omitted, changed (in scope, order, placement, etc.) or the like. Accordingly, those of skill in the art will recognize that many modifications may be made without departing from the scope of the present invention.

III.) Analysis

The invention provides for a method of analyzing data that is compiled as a result of the manufacturing of insulin. Further the invention provides for the analysis of data that is compiled as a result of a QA program used to monitor the manufacture of insulin in order to maintain the highest level of data integrity. In one embodiment, the parameters of the data will be defined by the quality control unit. Generally, the quality control unit will provide endpoints that need to be achieved to conform to cGMP regulations or in some instances an internal endpoint that is more restrictive to the minimum levels that need to be achieved.

In a preferred embodiment, the invention provides for data analysis using boundary value analysis. The boundary value will be set forth by the quality control unit. Using the boundary values set forth for a particular phase of insulin manufacture the algorithm is defined. Once the algorithm is defined, an algorithm analysis (i.e. logic analysis) takes place. One of skill in the art will appreciate that a wide variety of tools are used to confirm algorithm analysis such as an accuracy study processor.

One of ordinary skill will appreciate that different types of data will require different types of analysis. In a further embodiment, the program provides a method of analyzing block data via a block check. If the block check renders an affirmative analysis, the benchmark has been met and the analysis continues to the next component. If the block check renders a negative the data is flagged via standard recognition files known in the art and a hazard analysis and hazard mitigation occurs.

In a further embodiment, the invention provides for data analysis using branch analysis. The test cases will be set forth by the quality control unit.

In a further embodiment, the invention provides for data analysis using control flow analysis. The control flow analysis will calibrate the design level set forth by the quality control unit which is generated in the design phase.

In a further embodiment, the invention provides for data analysis using failure analysis. The failure analysis is initiated using the failure benchmark set forth by the quality control unit and then using standard techniques to come to error detection. The preferred technique will be top-down. For example, error guessing based on quality control group parameters which are confirmed by error seeding.

In a further embodiment, the invention provides for data analysis using path analysis. The path analysis will be initiated after the design phase and will be used to confirm the design level. On of ordinary skill in the art will appreciate that the path analysis will be a dynamic analysis depending on the complexity of the program modification. For example, the path analysis on the output of an insulin product will be inherently more complex that the path analysis for the validation of an in-process material. However, one of ordinary skill will understand that the analysis is the same, but the parameters set forth by the quality control unit will differ.

In a further embodiment, the invention provides for data analysis using failure modes and effects analysis. The analysis of actual or potential failure modes within an insulin manufacturing system on a component-by-component and process-by-process level is analyzed for classification or determination of a failure upon the insulin manufacturing system. Failures which cause any error or defects in an insulin process, design, manufacture, or product are analyzed and corrective action is taken during insulin manufacture. The corrective action of the invention comprises modifying or stopping insulin manufacture to obviate a failure.

In a further embodiment, the invention provides for data analysis using root cause analysis. The analysis occurs by identifying a root cause of a failure or hazard with the intention of eliminating the root cause thereby reducing its frequency on future insulin batches.

In a further embodiment, the invention provides for data analysis using hazard analysis and critical control points. The analysis occurs in a systematic preventive approach to insulin manufacturing that addresses physical, chemical, and biological hazards of insulin as a means of prevention rather than finished insulin product inspection. The analysis is used in insulin manufacture to identify hazards, so that key actions and locations within an insulin manufacturing process, known as critical control points can be taken to reduce or eliminate the risk of the hazards being realized. The analysis is used at all stages of insulin production including synthesis, blending, and packaging. Failures which cause any error or defects in an insulin process, design, manufacture, or product are analyzed and corrective action is taken during insulin manufacture. The corrective action of the invention comprises modifying or stopping insulin manufacture to obviate a failure.

The invention provides for a top-down design to software analysis. This preferred embodiment is advantageous because the parameters of analysis will be fixed for any given process and will be set forth by the quality control unit. Thus, performing software safety code analysis then software safety design analysis, then software safety requirements analysis, and then software safety test analysis will be preferred.

The aforementioned analysis methods are used for several non-limiting embodiments, including but not limited to, validating QA software, validating insulin manufacturing processes and systems, and validating process designs wherein the integration of the system design will allow for more efficient determination of acceptance criteria in a batch, in-process material, batch number, control number, and lot number and allow for increased access time thus achieving a more efficient cost-saving insulin manufacturing process.

IV. Execution System(s)

In one embodiment, the software program or computer product, as the case may be, is integrated into an execution system that controls the insulin manufacturing process. It will be understood by one of skill in the art that the software programs or computer products integrates the hardware via generally understood devices in the art (i.e. attached to the analog device via an analog to digital converter).

The tools of the execution system of the invention focus on less variance, higher volumes, tighter control, and logistics of insulin manufacturing. One of ordinary skill in the art will understand that an ES of the invention posseses attributes to increase traceability, productivity, and quality of an insulin product. One of ordinary skill in the art will understand that the aforementioned attributes are achieved by monitoring such insulin manufacturing functions including, for example, equipment tracking, product genealogy, labor and item tracking, costing, electronic signature capture, defect and resolution monitoring, executive dashboards, and other various reporting functions.

The software program or computer product is integrated into the execution system on a device-by-device basis. As previously set forth, the acceptance criteria of all devices used in insulin manufacture for the purposes of the execution system are determined by the quality control unit. The analysis of the insulin manufacturing occurs using any of the methods disclosed herein. (See, section III entitled “Analysis”). The program monitors and processes the data and stores the data using standard methods. The data is provided to an end user or a plurality of end users for assessing the quality of data generated by the device or devices. Furthermore, the data is stored for comparative analysis to previous batches to provide a risk-based assessment in case of failure. Using the historical analysis will provide a more streamlined insulin manufacturing process and will monitor to ensure that product quality is maximized. Utilizing the historical record will provide insulin manufacturers an “intelligent” perspective to manufacturing. Over time, the execution system will teach itself and modify the insulin manufacturing process in a way to obviate previous failures while at the same time continuously monitoring for new or potential failures. In addition, the invention comprises monitoring the data from initial process, monitoring the data at the end process, and monitoring the data from a routine maintenance schedule to ensure the system maintain data integrity and validation standards predetermined by the quality control unit.

V.) Kits/Articles of Manufacture

For use in basic input/output systems, hardware calibrations, software calibrations, computer systems audits, computer system security certification, data validation, different software system analysis, quality control, and the manufacturing of insulin products described herein, kits are within the scope of the invention. Such kits can comprise a carrier, package, or container that is compartmentalized to receive one or more containers such as boxes, shrink wrap, and the like, each of the container(s) comprising one of the separate elements to be used in the method, along with a program or insert comprising instructions for use, such as a use described herein.

The kit of the invention will typically comprise the container described above and one or more other containers associated therewith that comprise materials desirable from a commercial and user standpoint, programs listing contents and/or instructions for use, and package inserts with instructions for use.

A program can be present on or with the container. Directions and or other information can also be included on an insert(s) or program(s) which is included with or on the kit. The program can be on or associated with the container.

The terms “kit” and “article of manufacture” can be used as synonyms.

The article of manufacture typically comprises at least one container and at least one program. The containers can be formed from a variety of materials such as glass, metal or plastic.

VI.) Background to Insulin Manufacturing

A. Raw Materials

Generally, human insulin is grown in the lab inside common bacteria. Escherichia coli is by far the most widely used type of bacterium, but yeast is can also be used. In order to begin, manufacturers need the human protein that produces insulin. Manufacturers get this through an amino-acid sequencing machine that synthesizes the DNA. Manufacturers know the exact order of insulin's amino acids (the nitrogen-based molecules that line up to make up proteins). There are 20 common amino acids. Manufacturers input insulin's amino acids, and the sequencing machine connects the amino acids together. Also necessary to synthesize insulin are large tanks to grow the bacteria, and nutrients are needed for the bacteria to grow. Several instruments are necessary to separate and purify the DNA such as a centrifuge, along with various chromatography and x-ray crystallography instruments.

B. The Manufacturing Process

Generally, in common form, synthesizing human insulin is a multi-step biochemical process that depends on basic recombinant DNA techniques and an understanding of the insulin gene. DNA carries the instructions for how the body works and one small segment of the DNA, the insulin gene, codes for the protein insulin. Manufacturers manipulate the biological precursor to insulin so that it grows inside simple bacteria. While manufacturers each have their own variations, there are three (3) basic methods to manufacture human insulin.

(i) Human Insulin

When working with human insulin the first step is to obtain the insulin gene, for identification and characterization of the insulin gene and various analogs (See, United States Patent Application Publication US2004/0096459, published 20 May 2004). The insulin gene is a protein consisting of two separate chains of amino acids, an A above B chain that are held together with bonds. Amino acids are the basic units that build all proteins. The insulin A chain consists of 21 amino acids and the insulin B chain has 30 amino acids. In manufacturing, before becoming an active insulin protein, insulin is first produced as preproinsulin. This is one single long protein chain with the A and B chains not yet separated, a section in the middle linking the chains together and a signal sequence at one end telling the protein when to start secreting outside the cell. After preproinsulin, the chain evolves into proinsulin, still a single chain but without the signaling sequence. Then comes the active protein insulin, the protein without the section linking the A and B chains. At each step, the protein needs specific enzymes (proteins that carry out chemical reactions) to produce the next form of insulin. Assuming that a manufacturer is starting with both an A and B chain, which is preferred since it will avoid manufacturing each of the specific enzymes needed, then manufacturers need the two mini-genes; one that produces the A chain and one that produces the B chain. Since the exact DNA sequence of each chain is known, they synthesize each mini-gene's DNA in a commercially available amino acid sequencing machine. Then, these two DNA molecules are then inserted into plasmids, small circular pieces of DNA that are more readily taken up by the host's DNA. Manufacturers first insert the plasmids into a non-harmful type of the bacterium E. coli. They insert it next to the lacZ gene (See for example, InvivoGen, San Diego, Calif.). LacZ encodes for 8-galactosidase, a gene widely used in recombinant DNA procedures because it is easy to find and cut, allowing the insulin to be readily removed so that it does not get lost in the bacterium's DNA. Next to this gene is the amino acid methionine (M), which starts the protein formation. The recombinant, newly formed, plasmids are mixed up with the bacterial cells. Plasmids enter the bacteria in a process called transfection. Manufacturers can add to the cells DNA ligase (See for example, Sigma-Aldrich, St. Louis, Mo.), an enzyme that acts like glue to help the plasmid stick to the bacterium's DNA. The bacteria synthesizing the insulin then undergo a fermentation process. They are grown at optimal temperatures in large tanks in manufacturing plants. The millions of bacteria replicate roughly every 20 minutes through cell mitosis, and each expresses the insulin gene. After multiplying, the cells are taken out of the tanks and broken open to extract the DNA. One common way this is done is by first adding a mixture of lysozome that digest the outer layer of the cell wall, then adding a detergent mixture that separates the fatty cell wall membrane. The bacterium's DNA is then treated with cyanogen bromide (See for example, Sigma-Aldrich, St. Louis, Mo.), a reagent that splits protein chains at the methionine residues. This separates the insulin chains from the rest of the DNA. The two chains are then mixed together and joined by disulfide bonds through the reduction-reoxidation reaction. An oxidizing agent (a material that causes oxidization or the transfer of an electron) is added. The batch is then placed in a centrifuge, a mechanical device that spins quickly to separate cell components by size and density. The DNA mixture is then purified so that only the insulin chains remain. Manufacturers can purify the mixture through several chromatography, or separation, techniques that exploit differences in the molecule's charge, size, and affinity to water. Procedures used include, but are not limited to, an ion-exchange column, reverse-phase high performance liquid chromatography, and a gel filtration chromatography column. Manufacturers can test insulin batches to ensure none of the bacteria's E. coli proteins are mixed in with the insulin. They use a marker protein that lets them detect E. coli DNA. They can then determine that the purification process removes the E. coli bacteria. After synthesizing the human insulin, the structure and purity of the insulin batches are tested through several different methods. High performance liquid chromatography is used to determine if there are any impurities in the insulin. Other separation techniques, such as X-ray crystallography, gel filtration, and amino acid sequencing, are also performed. Manufacturers also test the vial's packaging to ensure it is sealed properly.

(ii) Proinsulin Methods

In approximately 1986, many manufacturers began to use another method to synthesize human insulin. They started with the direct precursor to the insulin gene, proinsulin. Many of the steps are the same as when producing insulin with the A and B chains (supra), except in this method the amino acid machine synthesizes the proinsulin gene. The sequence that codes for proinsulin is inserted into the non-pathogenic E. coli bacteria. The bacteria go through the fermentation process where it reproduces and produces proinsulin. Then the connecting sequence between the A and B chains is spliced away with an enzyme and the resulting insulin is purified. At the end of the manufacturing process ingredients are added to insulin to prevent bacteria and help maintain a neutral balance between acids and bases. Ingredients are also added to intermediate and long-acting insulin to produce the desired duration type of insulin. This is the traditional method of producing longer-acting insulin. Manufacturers add ingredients to the purified insulin that prolong their actions, such as zinc oxide. These additives delay absorption in the body. Additives vary among different brands of the same type of insulin depending on the specific properties of insulin that is desired.

(iii) Analog Insulin

In the mid 1990s, researchers began to improve the way human insulin works in the body by changing its amino acid sequence and creating an analog, a chemical substance that mimics another substance well enough that it fools the cell. Analog insulin clumps less and disperses more readily into the blood, allowing the insulin to start working in the body minutes after an injection. There are several different analog insulin. Humulin insulin does not have strong bonds with other insulin and thus, is absorbed quickly. Another insulin analog, called Glargine, changes the chemical structure of the protein to make it have a relatively constant release over 24 hours with no pronounced peaks. Instead of synthesizing the exact DNA sequence for insulin, manufacturers synthesize an insulin gene where the sequence is slightly altered. The change causes the resulting proteins to repel each other, which causes less clumping. Using this changed DNA sequence, the manufacturing process is similar to the recombinant DNA process described.

### EXAMPLES

Various aspects of the invention are further described and illustrated by way of the several examples that follow, none of which is intended to limit the scope of the invention.

### Example 1

### Utilizing the Execution System to monitor the Insulin Synthesis Process for Insulin Manufacture

Generally, Insulin is produced by the beta cells in the islets of Langerhans in the pancreas. Persons who cannot produce insulin or cannot produce enough insulin suffer from a disease commonly known as diabetes. Treatment of diabetes requires taking insulin on a regimented basis. Accordingly, the efficient manufacturing of insulin provides quality insulin to those who need it.

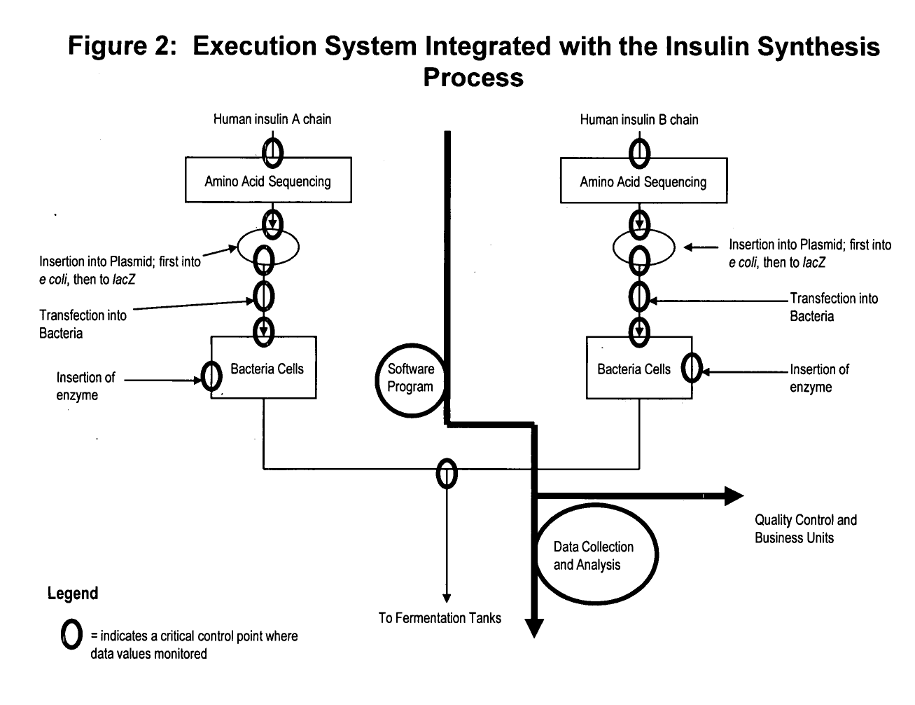

Generally speaking and for purposes of this example, manufacturers begin with two amino acid chains coding for the A and B chain of human insulin. The chains are sequenced in an amino acid sequencing machine to confirm the proper amino acids exist. The amino acid sequences are first inserted into an e coli plasmid and then into a lacZ plasmid and then transfected into bacteria cells (FIG. 2). Enzymes such as DNA ligase are added to further support the replication of the insulin protein. The synthesis process is completed and the A and B chains are sent to the fermentation tanks. (FIG. 2).

In one embodiment, the Execution System (“ES”) is integrated into the insulin synthesis system used in insulin manufacture: It will be understood by one of skill in the art that the ES integrates the hardware via generally understood devices in the art (i.e. attached to the analog device via an analog to digital converter). The ES is integrated into the insulin synthesis system on a device-by-device basis. As previously set forth, the acceptance criteria of all devices used in the insulin manufacture for the purposes of the insulin synthesis process are determined by the quality control unit. The analysis of the software and hardware occurs using any of the methods disclosed herein. The ES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined insulin synthesis process and will monitor to ensure that the insulin synthesis system data is integrated into subsequent insulin manufacturing processes.

In addition, the invention comprises monitoring the data from initial process, monitoring the data at the end process, and monitoring the data from a routine maintenance schedule to ensure the system maintain data integrity and validation standard predetermined by the quality control unit. (See, FIG. 2).

In one embodiment, the monitoring and analysis of the insulin synthesis systems achieves a step of integration into an execution system whereby manufacturing productivity and product quality are increased. Costs are streamlined over time.

### Example 2

### Utilizing the Execution System to Monitor the Fermentation and DNA Extraction Process for Insulin Manufacture

Generally speaking and for purposes of this example, fermentation is a process of energy production in a cell in an anaerobic environment (with no oxygen present). In common usage fermentation is a type of anaerobic respiration. When a particular organism is introduced into a selected growth medium, the medium is inoculated with the particular organism. Growth of the inoculum does not occur immediately, but takes a little while. This is the period of adaptation, called the lag phase. Following the lag phase, the rate of growth of the organism steadily increases, for a certain period, this period is the log or exponential phase. After a certain time of exponential phase, the rate of growth slows down, due to the continuously falling concentrations of nutrients and/or a continuously increasing (accumulating) concentrations of toxic substances. This phase, where the increase of the rate of growth is checked, is the deceleration phase. After the deceleration phase, growth ceases and the culture enters a stationary phase or a steady state. The biomass remains constant, except when certain accumulated chemicals in the culture lyse the cells (chemolysis). Unless other micro-organisms contaminate the culture, the chemical constitution remains unchanged. Mutation of the organism in the culture can also be a source of contamination, called internal contamination.

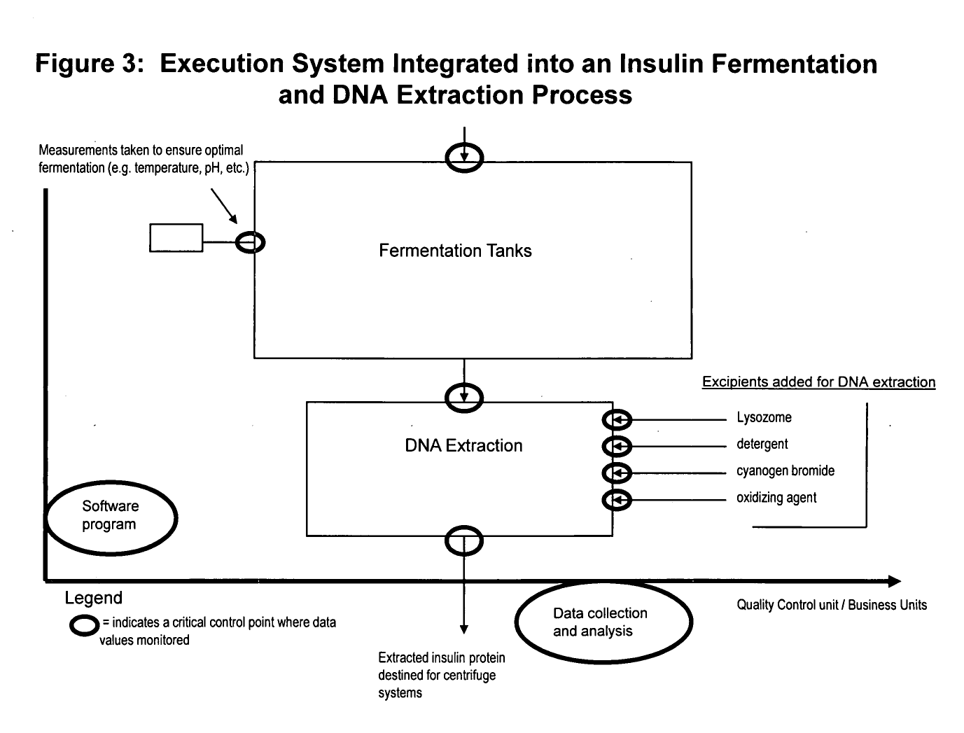

The insulin A and B chains are transfected into bacteria and sent to large mixing tanks to undergo fermentation. That is, to replicate to large scale. The millions of bacteria are grown at optimal tempuratures, pH, concentration, etc. and replicate approxiamtely every twenty (20) minutes through cell mitosis and each expresses the insulin gene (FIG. 3). After multiplying, the cells are taken out of the mixing tanks and broken open to extract the DNA (this process is commonly referred to as DNA extraction).

DNA extraction is a routine procedure to collect DNA for subsequent molecular analysis. DNA can be quantified by cutting the DNA with a restriction enzyme, running it on an agarose gel, staining with ethidium bromide or a different stain and comparing the intensity of the DNA with a DNA marker of known concentration. Further, measuring the intensity of absorbance of the DNA solution at wavelengths 260 nm and 280 nm is used as a measure of DNA purity. DNA absorbs UV light at 260 and 280 nm, and aromatic proteins absorbs UV light at 280 nm; a pure sample of DNA has the 260/280 ratio at 1.8 and is relatively free from protein contamination. A DNA preparation that is contaminated with protein will have a 260/280 ratio lower than 1.8.

In insulin manufacturing, one common way this is done is by first adding a mixture of lysozome that digest the outer layer of the cell wall, then adding a detergent mixture that separates the fatty cell wall membrane. The bacterium's DNA is then treated with cyanogen bromide (See for example, Sigma-Aldrich, St. Louis, Mo.), a reagent that splits protein chains at the methionine residues. This separates the insulin chains from the rest of the DNA. The two chains are then mixed together and joined by disulfide bonds through the reduction-reoxidation reaction. An oxidizing agent (a material that causes oxidization or the transfer of an electron) is added. (FIG. 3).

Prior to insulin purification processing, the extracted insulin are mixed and joined via chemical bond. Accordingly, the insulin is fermented and extracted. If the quality tests are negative, corrective action occurs. If the quality tests are positive the insulin proceeds to purification.

In one embodiment, the ES is integrated into the fermentation and DNA extraction system used in insulin manufacture. It will be understood by one of skill in the art that the ES integrates the hardware via generally understood devices in the art (i.e. attached to the analog device via an analog to digital converter). The ES is integrated into the fermentation and DNA extraction system on a device-by-device basis. As previously, set forth, the acceptance criteria of all devices used in insulin manufacture for the purposes of fermentation and DNA extraction are determined by the quality control unit. The analysis of the software and hardware occurs using any of the methods disclosed herein. The ES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined fermentation and DNA extraction process and will monitor to ensure that the fermentation and DNA extraction system data is integrated into purification and other systems.

In addition, the invention comprises monitoring the data from initial process, monitoring the data at the end process, and monitoring the data from a routine maintenance schedule to ensure the system maintain data integrity and validation standard predetermined by the quality control unit. (See, FIG. 3).

In one embodiment, the monitoring and analysis of the fermentation and DNA extraction systems achieves a step of integration into an execution system whereby manufacturing productivity and product quality are increased. Costs are streamlined over time.

### Example 3

### Utilizing the Execution System to monitor the Purification Process for Insulin Manufacture

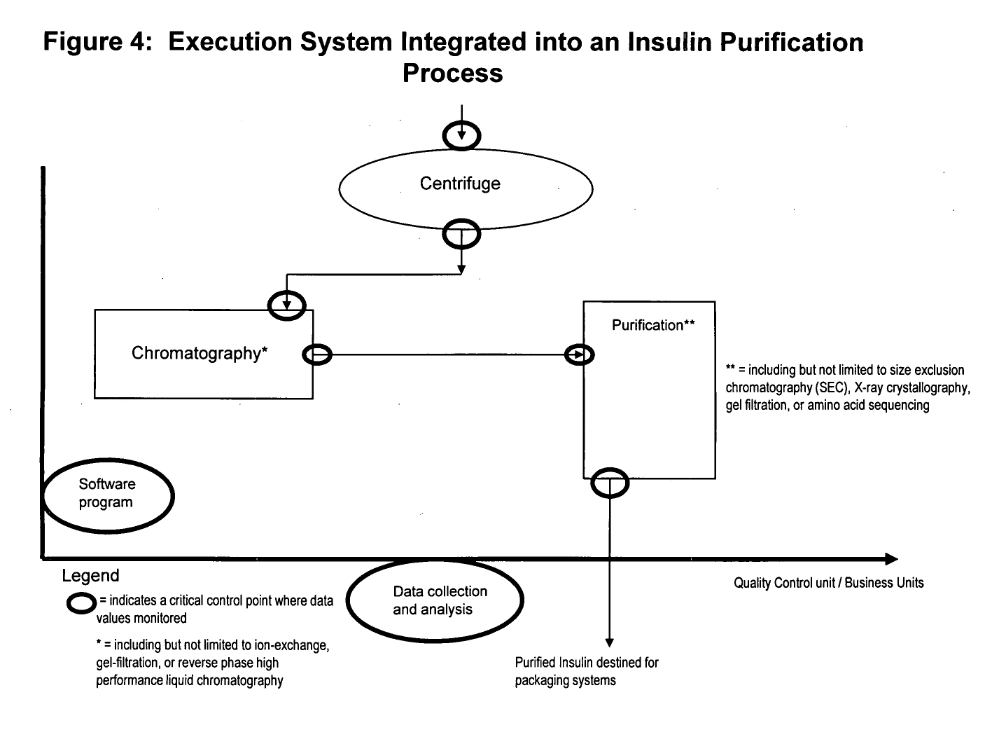

In insulin manufacturing purification refers to the process of rendering something pure, i.e. insulin clean of foreign elements and/or pollution. This takes place in a multi-step process. First, the batch is placed in a centrifuge which separates solids from liquids, or separates two immiscible liquids, on the basis of density. This will ensure that the bonded A and B insulin chains are separated into a homogenous mixture. Second, the insulin is purified using several techniques including but not limited to, an ion-exchange column, reverse-phase high performance liquid chromatography, and a gel filtration chromatography column. This will allow the batch to be purified based on a variety of properties such as the molecule's charge, size, and affinity to water. (FIG. 4). Different purification techniques may be used to determine or purify based on specific properties.

For example, Ion exchange chromatography utilizes ion exchange mechanism to separate analytes. It is usually performed in columns but the mechanism can be benefited also in planar mode. Ion exchange chromatography uses a charged stationary phase to separate charged compounds including insulin proteins. In conventional methods the stationary phase is an ion exchange resin that carries charged functional groups which interact with oppositely charged groups of the compound to be retained. Ion exchange chromatography is commonly used to purify proteins using FPLC.

Additionally, reversed-phase chromatography (RPC) is an elution procedure used in liquid chromatography in which the mobile phase is significantly more polar than the stationary phase.

Size exclusion chromatography (SEC) is also known as gel permeation chromatography (GPC) or gel filtration chromatography and separates molecules according to their size (or more accurately according to their hydrodynamic diameter or hydrodynamic volume). Smaller molecules are able to enter the pores of the media and; therefore, take longer to elute, whereas larger molecules are excluded from the pores and elute faster. It is generally a low resolution chromatography technique and thus it is often reserved for the final, “polishing” step of a purification. In the context of insulin manufacturing, it is also useful for determining the tertiary structure and quaternary structure of purified insulin proteins, since it can be carried out under native solution conditions.

In one embodiment, the extracted insulin culture (See, Example 2 entitled “Utilizing the Execution System to monitor the Fermentation and DNA Extraction Process for insulin manufacture) is ran through a centrifuge phase (See, FIG. 4). The culture is filtered and purified to the proper parameters and is sent to the purification chromatography phase.

Once the product is purified, it is stored using standard methods in a storage tank (FIG. 4). The product is transferred to a polishing chromatography phase where it is filtered, purified, and forwarded to formulation and filling (FIG. 4).

In one embodiment, the ES is integrated into the purification system used in insulin manufacture. It will be understood by one of skill in the art that the ES integrates the hardware via generally understood devices in the art (i.e. attached to the analog device via an analog to digital converter). The ES is integrated into the purification system on a device-by-device basis. As previously, set forth, the acceptance criteria of all devices used in insulin manufacture for the purposes of the purification process are determined by the quality control unit. The analysis of the software and hardware occurs using any of the methods disclosed herein. The ES monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined purification process and will monitor to ensure that the purification system data is integrated into the purification processes. In addition, the invention comprises monitoring the data from initial process, monitoring the data at the end process, and monitoring the data from a routine maintenance schedule to ensure the system maintain data integrity and validation standard predetermined by the quality control unit. (See, FIG. 4).

In one embodiment, the monitoring and analysis of the purification systems achieves a step of integration into an execution system whereby manufacturing productivity and product quality are increased. Costs are streamlined over time.

### Example 4

### Utilizing the Execution System to Monitor a Packaging Process for Insulin Manufacture

### Background:

Packaging of insulin products are important aspects of the insulin manufacturing process given that the finished insulin product is ultimately distributed to the consumer. Currently, all insulin delivery devices inject insulin through the skin and into the fatty tissue below. Most people inject the insulin with a syringe that delivers insulin just under the skin. Others use insulin pens, jet injectors, or insulin pumps. Several alternative approaches for taking insulin include but are not limited to implantable insulin pumps, insulin pills, and insulin patches. Accordingly, the need for safe uniform packaging is apparent to one of skill in the art.

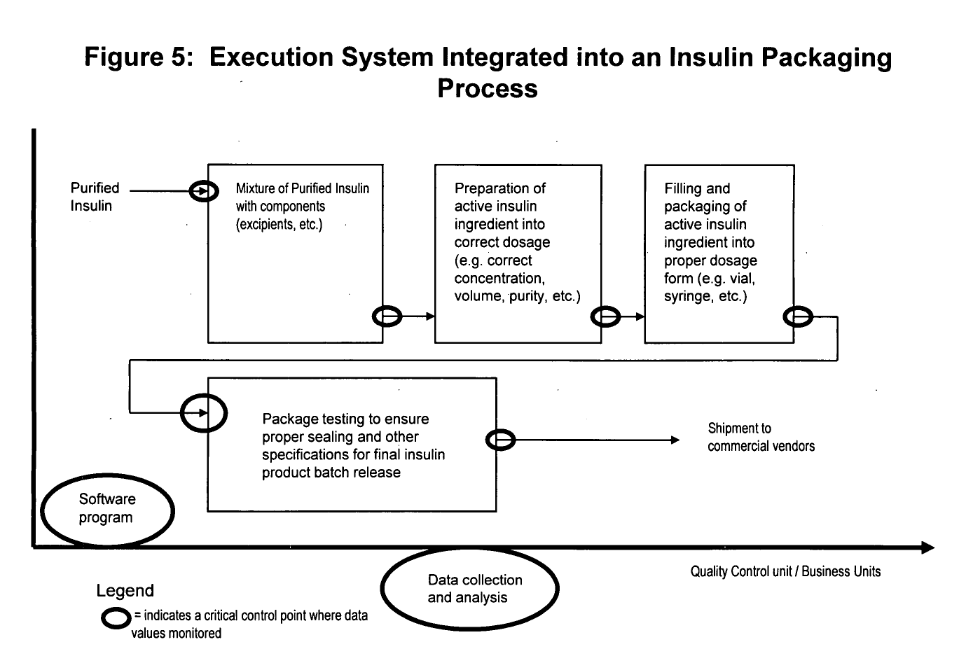

In one embodiment, the purified insulin (See, Example 3 entitled “Utilizing the Execution System to monitor the Purification process for insulin manufacture”) is set to finishing and packaging and active insulin is formed into the proper dosage form and checked for uniform properties (See, FIG. 5). The active insulin ingredient is filled into the proper dosage form. (FIG. 5).

Once the insulin product is filled and sealed the package is tested to ensure proper sealing prior to shipment to commercial vendors, it is then stored using standard methods. (FIG. 5).

In one embodiment, the execution system is integrated into the packaging system hardware. It will be understood by one of skill in the art that the execution system integrates the hardware via generally understood devices in the art (i.e. attached to the analog device via an analog to digital converter).

The computer product is integrated into the packaging system on a device-by-device basis. (FIG. 5). As previously set forth, the acceptance criteria of all devices used in the insulin product manufacture for the purposes of the packaging process are determined by the quality control unit. The analysis of the software and hardware occurs using any of the methods disclosed herein. The program monitors and processes the data and stores the data using standard methods. The data is provided to an end user or a plurality of end users for assessing the quality of data generated by the device. Furthermore, the data is stored for comparative analysis to previous insulin batches to provide a risk-based assessment in case of failure. Using the historical analysis will provide a more streamlined packaging process and will monitor to ensure that ingredients are mixed properly. In addition, the invention comprises monitoring the data from initial process, monitoring the data at the end process, and monitoring the data from a routine maintenance schedule to ensure the system maintain data integrity and validation standard predetermined by the quality control unit.

In one embodiment, the monitoring and analysis of the packaging systems achieves a step of integration into an execution system whereby manufacturing productivity and product quality are increased. Costs are streamlined over time.

### Example 5

### Utilization of Execution System in Commercial Insulin Manufacturing Processes

The invention comprises a method for monitoring the acceptance criteria of all components used in insulin manufacture. The analysis of the software and hardware occurs using any of the methods disclosed herein. The program monitors and processes the data and stores the data using methods known in the art. The data is provided to an end user or a plurality of end users for assessing the quality of the insulin batch. Furthermore, the data is stored for comparative analysis to previous insulin batches to provide a risk-based assessment in case of failure. Using the historical analysis will provide a more streamlined insulin manufacturing approach and will provide cost-saving over time. In addition, the invention comprises monitoring the data from initial process, monitoring the data at the end process, and monitoring the data from a routine maintenance schedule to ensure the system maintain data integrity and validation standard predetermined by the quality control unit.

### Example 6

### Integration of Execution System into an Insulin Manufacturing Hardware System

The invention comprises the integration of the execution system into an insulin manufacturing hardware system. In this context, the term “hardware” means any physical device used in the insulin manufacturing process including, but not limited to, blenders, bioreactors, capping machines, chromatography/separation systems, chilled water/circulating, glycol, coldrooms, clean steam, clean-in-place (CIP), compressed air, D.I./R.O. watersystems, dry heat sterilizers/ovens, fermentation equipment/bioreactors, freezers, filling equipment, filtration/purification, HVAC, environmental controls, incubators, environmentally controlled chambers, labelers, lyophilizers, dryers, mixing tanks, modular cleanrooms, neutralization systems, plant steam and condensation systems, process tanks, pressure systems, vessels, refrigerators, separation/purification equipment, specialty gas systems, steam generators/pure steam systems, steam sterilizers, stopper washers, solvent recovery systems, tower water systems, waste inactivation systems, “kill” systems, vial inspection systems, vial washers, water for injection (WFI) systems, pure water systems, washers (glass, tank, carboys, etc.), centrifuges, oxidizing systems, DNA extraction systems, amino acid sequencing systems.

It will be understood by one of skill in the art that the execution system integrates the hardware via generally understood devices in the art (i.e. attached to the analog device via an analog to digital converter).

The execution system is integrated into the manufacturing system on a device-by-device basis. (FIG. 2-FIG. 5). As previously set forth, the acceptance criteria of all devices used in the insulin product manufacture for the purposes of the insulin manufacturing process are determined by the quality control unit. The analysis of the software and hardware occurs using any of the methods disclosed herein. The program monitors and processes the data and stores the data using standard methods. The data is provided to an end user or a plurality of end users for assessing the quality of data generated by the device. Furthermore, the data is stored for comparative analysis to previous batches to provide a risk-based assessment in case of failure. Using the historical analysis will provide a more streamlined insulin manufacturing approach and will provide cost-saving over time. In addition, the invention comprises monitoring the data from initial process, monitoring the data at the end process, and monitoring the data from a routine maintenance schedule to ensure the system maintain data integrity and validation standard predetermined by the quality control unit.

### Example 7

### Integration of the Execution System into an Insulin Manufacturing Software System

The invention comprises the integration of an execution system into an insulin manufacturing software system. In this context, the term “software” means any device used in the insulin manufacturing process including, but not limited to user-independent audit trails, time-stamped audit trails, data security, confidentiality systems, limited authorized system access, electronic signatures, bar codes, dedicated systems, add-on systems, control files, Internet, LAN's, portable handheld devices, etc.

The execution system is integrated into the insulin manufacturing system on a device-by-device basis. (FIG. 2-FIG. 5). As previously set forth, the acceptance criteria of all devices used in insulin manufacture for the purposes of the insulin manufacturing process are determined by the quality control unit. The analysis of the software and hardware occurs using any of the methods disclosed herein. The execution system monitors and processes the data and stores the data using standard methods. The data is provided to an end user or a plurality of end users for assessing the quality of data generated by the device. Furthermore, the data is stored for comparative analysis to previous insulin batches to provide a risk-based assessment in case of failure. Using the historical analysis will provide a more streamlined insulin manufacturing approach and will provide cost-saving over time. In addition, the invention comprises monitoring the data from initial process, monitoring the data at the end process, and monitoring the data from a routine maintenance schedule to ensure the system maintain data integrity and validation standard predetermined by the quality control unit.

### Example 8

### Integration of Execution System and Analysis Methods into a Comprehensive Cost-Saving System

The invention comprises an execution system integrated into a comprehensive cost-saving insulin manufacturing system. A user, preferably a system administrator, logs onto the system via secure means (i.e. password or other security measures known in the art) and inputs the boundary values for a particular component of the insulin manufacturing process (i.e. upper and lower limits of pH, temperature, concentration, volume, blending speed, etc.) The input is at the initial stage of insulin manufacture, the end product stage of insulin manufacture, or any predetermined interval in between that has been established for routine maintenance by the quality control unit. The data is generated using any one of the various analysis methods described herein (as previously stated the type of analysis used is functional to the device or protocol being monitored or evaluated). Subsequent to the data analysis, any modifications or corrective action to the insulin manufacturing process is implemented. The data is then stored by standard methods known in the art. Scheduled analysis of the stored data is maintained to provide a preventative maintenance of the insulin manufacturing process. Over time, costs are reduced due to the tracking of data and analysis of troubled areas and frequency of hazards that occur on any given device in the insulin manufacturing process. The system is implemented on every device which plays a role in insulin manufacturing. (FIG. 2-FIG. 5). The data compiled from every device is analyzed using the methods described herein.

### Example 9

### Integration of Method(s) and Program(s) into an Execution System (ES)

### Background:

A paradigm shift is needed in the way insulin is manufactured. Current processes are not readily understood by the industry at-large and the processes are time consuming and produce lower quality products. One of ordinary skill will appreciate that a lower quality insulin batch is essentially, a waste. Often the insulin batch must be run again using different production and system parameters. Quality control units that can continuously monitor a specific insulin manufacturing process and use that data, via data analysis methods disclosed herein, will allow insulin manufacturers to produce higher quality insulin products in a faster timeframe. The fountainhead goal is to build quality into an insulin product, rather than test for quality after the insulin product is made. One of ordinary skill in the art will understand that the former method is advantageous since it will be easier to locate a defect in insulin manufacturing if monitoring is continuous rather that post-production or post-process. It is an object of the invention to provide this advantage.

### Integration:

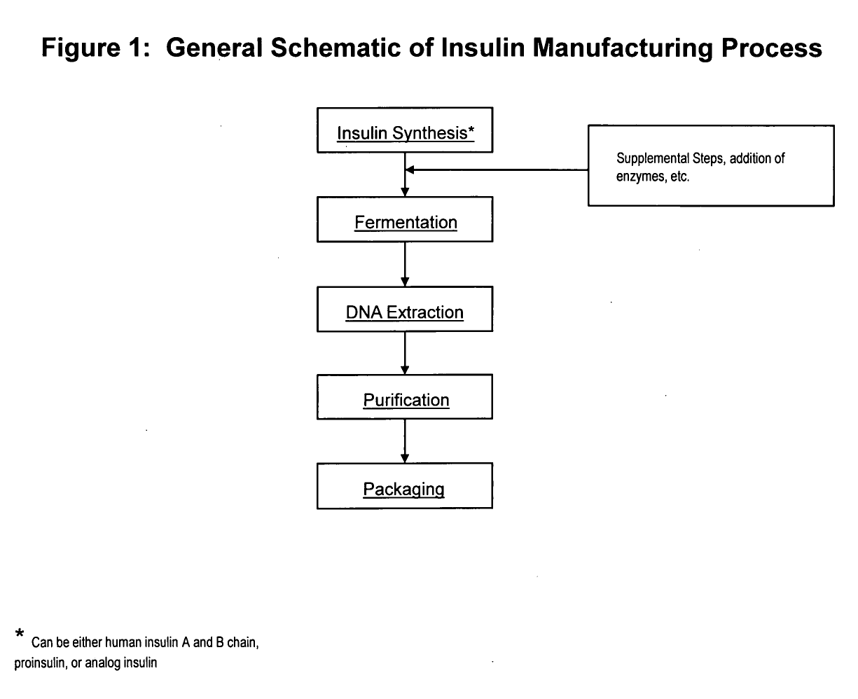

In one embodiment, the software program is integrated into an execution system that controls the insulin manufacturing process (generally set forth in FIG. 1). It will be understood by one of skill in the art that the software program/computer product integrates the hardware via generally understood devices in the art (i.e. attached to the analog device via an analog to digital converter).

The software program/computer product is integrated into an execution system on a device-by-device basis. (FIG. 2-FIG. 5). As previously set forth, the acceptance criteria of all devices used in insulin manufacture for the purposes of the execution system are determined by the quality control unit. (FIG. 2-FIG. 5). The analysis of the software and hardware occurs using any of the methods disclosed herein. The program monitors and processes the data and stores the data using standard methods. The data is provided to an end user or a plurality of end users for assessing the quality of data generated by the device or devices. Furthermore, the data is stored for comparative analysis to previous insulin batches to provide a risk-based assessment in case of failure. Using the historical analysis will provide a more streamlined insulin manufacturing process and will monitor to ensure that insulin product quality is maximized. In addition, the invention comprises monitoring the data from initial process, monitoring the data at the end process, and monitoring the data from a routine maintenance schedule to ensure the system maintain data integrity and validation standards predetermined by the quality control unit.

The present invention is not to be limited in scope by the embodiments disclosed herein, which are intended as single illustrations of individual aspects of the invention, and any that are functionally equivalent are within the scope of the invention. Various modifications to the models, methods, and life cycle methodology of the invention, in addition to those described herein, will become apparent to those skilled in the art from the foregoing description and teachings, and are similarly intended to fall within the scope of the invention. Such modifications or other embodiments can be practiced without departing from the true scope and spirit of the invention.

1) An execution system (“ES”) for use in an insulin manufacturing by a process comprising,
a) contacting the ES to a plurality of devices used in the insulin manufacturing process;
b) monitoring data generated by the ES during said insulin manufacturing process;
c) analyzing the data to provide a risk-based assessment in case of failure;
d) taking corrective action to obviate the failure wherein said corrective action comprises modifying said insulin manufacturing process.

2) The ES of claim 1, wherein the devices comprise at least a fermentation device or a purification device.

3) The ES of claim 1, wherein said monitoring is continuous.

4) A kit comprising the ES of claim 1.

5) A method of monitoring an insulin manufacturing process said method comprising,
a) deriving an algorithm implemented in computer-readable instructions that performs data analysis on an insulin manufacturing process;
b) contacting said algorithm to a device used in insulin manufacture;
c) analyzing the data to provide a risk-based assessment in case of failure;
d) taking corrective action to obviate the failure.

6) The method of clam 5, further comprising maintaining a historical record of the data analysis.

7) The method of claim 5, wherein the data analysis comprises failure modes and effects analysis.

8) The method of claim 5, wherein the monitoring comprises a critical control point.

9) The method of claim 8, wherein the critical control point monitors an active insulin ingredient.

10) The method of claim 8, wherein the critical control point monitors an in-process material.

11) The method of claim 5, wherein said insulin manufacturing process comprises an insulin packaging process.

12) A method of monitoring an acceptance criteria of an insulin manufacturing system, said method comprising,
a) monitoring data generated by an insulin manufacturing system during insulin manufacture;
b) maintaining the data over time to provide a historic record;
c) analyzing the historic record to provide a comparative analysis against an acceptance criteria;
d) taking corrective during insulin manufacture to obviate a rejection against an acceptance criteria.

13) The method of claim 12, comprising monitoring an acceptance criteria of an insulin synthesis system.

14) The method of claim 12, comprising monitoring an acceptance criteria of an insulin fermentation system.

15) The method of claim 12, comprising monitoring an acceptance criteria of an insulin DNA extraction system.

16) The method of claim 12, comprising monitoring an acceptance criteria of an insulin purification system.

17) The method of claim 12, comprising monitoring an acceptance criteria of an insulin packaging system.

18) An algorithm implemented in computer-readable instructions that performs the method of claim 12.

19) A kit comprising the computer-readable instructions of claim 18.
